(19) United States
(12) Patent Application Publication
(10) Pub. No.: US 2024/0325952 A1
(43) Pub. Date: Oct. 3, 2024

(54) INHERENTLY STABLE, FLOW-POROUS FILTER ELEMENT AND METHOD FOR PRODUCING SUCH A FILTER ELEMENT

(71) Applicant: Herding GmbH Filtertechnik, Amberg (DE)

(72) Inventors: Urs Herding, Amberg (DE); Stefan Hajek, Amberg (DE); Julian Raabe, Amberg (DE)

(73) Assignee: Herding GmbH Filtertechnik, Amberg (DE)

(21) Appl. No.: 18/027,704

(22) PCT Filed: Aug. 4, 2021
(86) PCT No.: PCT/EP2021/071814

§ 371 Date: Oct. 10, 2023

(30) Foreign Application Priority Data
Sep. 22, 2020 (DE) 10 2020 124 689.7

(51) Int. Cl. B01D 46/00; B01D 39/16; B01D 46/24; B01D 46/52; B33Y 10/00; B33Y 80/00

(52) U.S. Cl. CPC B01D 46/0001; B01D 39/1676; B01D 46/2403; B01D 46/521; B33Y 10/00; B33Y 80/00; B01D 2239/0471; B01D 2239/0654; B01D 2239/10; B01D 2265/06

(57) ABSTRACT

An inherently stable, throughflow-porous filter element for filtering foreign substances from a gas stream, comprising a filter body of plastic and having an inflow side and an opposite outflow side, wherein a surface filtration layer is formed on the inflow side, wherein the filter body has a three-dimensional support structure manufactured in an additive manufacturing process, said support structure having cavities through which gas can flow from the inflow side to the outflow side, and wherein the surface filtration layer at least partially fills the cavities of the three-dimensional support structure.

### BACKGROUND OF THE INVENTION

The invention relates to an inherently stable throughflow-porous filter element for filtering foreign substances from a gas stream. Furthermore, the invention also relates to a method of manufacturing an inherently stable throughflow-porous filter element for filtering foreign substances from a gas stream.

Such filter elements are used in factories and plants in a wide variety of industrial branches, for example in the automotive industry, the chemical industry, the food industry or in the production of building materials.

Up to now, filter bodies of such filter elements have been sintered and then provided with a surface filtration layer, e.g. in the form of a spray coating. Due to the nature of the process, the filter bodies are usually manufactured in several pieces, which are then joined together to form a single filter body. The sintering process permits the production of inherently stable filter elements in large numbers, but is subject to certain limitations, for example with regard to the plastics that can be used or the structure of filter body and/or surface filtration layer.

### SUMMARY OF THE INVENTION

It is the object of the present invention to provide an inherently stable, throughflow-porous filter element for filtering foreign substances from a gas stream, comprising a porous filter body and a surface filtration layer formed on the inflow side of the filter body, which is not subject to these limitations.

According to the invention, a filter element having inherent stability and being porous to permit flow therethrough, i.e. an inherently stable, throughflow-porous filter element for filtering foreign substances from a gas stream is suggested, comprising a filter body made of plastic and having an inflow side and an opposite outflow side, with a surface filtration layer being formed on the inflow side. The filter body comprises a three-dimensional support structure manufactured in an additive manufacturing process and having cavities through which gas can flow from the inflow side to the outflow side. The surface filtration layer at least partially fills the cavities of the three-dimensional support structure.

Furthermore, according to the invention, a method of manufacturing an inherently stable, throughflow-porous filter element for filtering foreign substances from a gas stream is suggested, wherein a filter body is formed of plastic and having an inflow side and an opposite outflow side. The method comprises at least the following steps: manufacturing a three-dimensional support structure by means of an additive manufacturing process such that cavities are formed in the three-dimensional support structure, through which gas can flow from the inflow side to the outflow side, and forming a surface filtration layer by partially filling the cavities of the three-dimensional support structure with a coating material.

The three-dimensional support structure is to be manufactured by means of an additive manufacturing process, in particular by laser sintering, stereolithography, in particular UV-based stereolithography or low force stereolithography, DLP, binder jetting, particle jetting, or FDM. Each of these processes results in a characteristic structure of the resulting three-dimensional support structure and, if applicable, other parts of the filter body, which are manufactured in the same way and, in particular, in the same manufacturing process as the three-dimensional support structure.

The additive manufacturing process permits the filter body to be manufactured with the respective desired geometry and mechanical properties, such as strength and rigidity, without being subject to limitations imposed by conventional processes. Additive manufacturing also offers the possibility of manufacturing the three-dimensional support structure together with the filter body. Additive manufacturing processes no longer require molds or formworks specifying the geometry of the component to be manufactured, but instead generate the component in computer controlled manner on the basis of digital 3D design data. In this way, filter elements of any size and geometry can be manufactured in a single process, in particular with a one-piece filter body and, if applicable, even in such a manner that filter body, connecting elements and at least parts of the surface filtration layer or parts for bonding a surface filtration layer applied in a separate manufacturing process are integral, i.e. are manufactured in one piece. The filter body and such parts can be manufactured in a single printing process, even if they have different geometries or if there are differences with regard to the material from which the filter body or the individual parts are made. Filter elements that have been manufactured using an additive manufacturing process can be recognized in particular by the fact that filter bodies and, if applicable, additional parts manufactured using additive manufacturing, usually have geometries that cannot be realized using a casting process, since additively manufactured components have, for example, cavities or undercuts and protrusions.

The three-dimensional support structure enables a permanently durable bond between the surface filtration layer and the filter body, even under heavy loads, as typically expected during operation (e.g. as a result of a strong inflow of raw gas carrying partially abrasive foreign particles and/or due to the application of pressure pulses during recurring cleaning cycles). The three-dimensional support structure is formed such that particles of the surface filtration layer (this applies in particular to particles of a first layer of the surface filtration layer described in more detail below) can wedge themselves in the support structure when the surface filtration layer is applied. The cavities are free spaces in the support structure through which the gas can flow. In this case, the cavities are formed by the support structure itself. Since the three-dimensional support structure is manufactured in an additive manufacturing process, it can in particular have cavities with the configuration of so-called parametrically controlled pores. This term is intended to express that the cavities or pores formed in the three-dimensional support structure by the additive manufacturing process can be specifically adjusted in size and shape to manufacture a corresponding three-dimensional support structure with cavities.

The support structure also ensures the stability of the filter element during its manufacturing process. In particular, the support structure manufactured by additive manufacturing enhances the stability of a green compact of the filter element before curing and post-processing.

The inflow side of the filter body describes the side from which a gas stream loaded with foreign substances reaches the filter element during filter operation and then penetrates through the surface filtration layer. The downstream side of the filter body describes the side on which the gas stream cleaned of foreign substances is discharged from the filter element. Accordingly, in an installed state of the filter element, the inflow side is directed towards a raw gas space of a filter system, and the outflow side of the filter body is directed towards a clean gas space of the filter system.

A filter body made of plastic is obtained when the filter body has a plastic as a main constituent. In addition to the main constituent of plastic, other constituents may be present in the filter body, for example in the form of additives or fillers. It is not important whether such further constituents are plastics or have a non-plastic material. The plastic for the manufacture of the filter body can be formed from one polymer material or from several polymer materials (for example in the form of a polymer blend or mixed polymer). When the composition of a plastic is referred to in the following, for example in connection with the filter body and/or the filter element, this always is to be understood in the sense that the plastic can be formed from only one polymer material or from several polymer materials. The term polymer material is to be understood in general terms and is intended to include both homopolymers composed of monomers of the same type and copolymers such as block copolymers and other polymers composed of different types of monomers.

Additively manufactured filter elements can be produced with such precision that only very few to no post-processing steps are required. Filter elements with a wide range of geometries and sizes can also be manufactured in this way.

Possible embodiments and further developments are described in the dependent claims and will be explained in the following. These embodiments and further developments are expressly intended to refer both to the filter element according to the invention and to the manufacturing method according to the invention. It is understood that the respective described embodiments and further embodiments may be combined with each other, if desired, unless it is expressly indicated for individual aspects that these are alternatives to each other.

In particular, the three-dimensional support structure may comprise a cage structure that is open towards the inflow side. In particular, such a cage structure may be designed such that material for forming the surface filtration layer is accommodated in individual cavities. The cavities each form a kind of cage, so that material accommodated in a respective cavity can be held by the three-dimensional support structure surrounding the cage. The cage structure in particular is designed such that material for forming the surface filtration layer can be introduced into a respective cage after the three-dimensional support structure has been manufactured. The material for forming the surface filtration layer can be particulate, at least when introduced into the cavities of the three-dimensional support structure. The cage structure then is designed such that the particles introduced into a cavity in each case are retained by the cage structure, so that in any case the predominant part of material that has been introduced into a cavity remains there and is not transported further through the bottom side or lateral boundaries of the cavity. To assist in retaining the particles in the cage structure, an adhesive system, such as glue or the like, may be used. The retention of material in the cavities can be further enhanced by the fact that the material for forming the surface filtration layer has such a configuration and/or is introduced into the cavities in such a way that particles of the material in the cavity combine with each other and form agglomerates. Such agglomerates may well extend across several adjacent cavities and thus form bridge structures that lead to particularly good anchoring of the material for the surface filtration layer in the cavities of the cage structure.

To form a cage-like structure, the three-dimensional support structure can in particular form basket-like, cup-like or funnel-like cavities, each having a bottom side and an opposite open side. In this case, the open side can face the inflow side, so that material for forming the surface filtration layer can be easily introduced into the cage structure through the open side.

The basket-like, cup-like or funnel-like cavities may each have a lateral boundary, for example in the manner of a side wall, connecting the bottom side to the open side and having openings through which adjacent ones of the basket-like, cup-like or funnel-like cavities communicate with each other. By means of such lateral boundaries, movements of particles of the material forming the surface filtration layer in the lateral direction can be interrupted or at least be hindered and/or guided to such an extent that “falling out” of these particles from the cavity and further transport in the direction of the outflow side and/or the inflow side is effectively suppressed. Through the openings formed in the lateral boundaries, however, particles of the material for the surface filtration layer can nevertheless bond with each other across adjacent cavities and thus form agglomerates or bridge structures that extend across several adjacent cavities. In this way, a secure anchorage of the material of the surface filtration layer in the three-dimensional support structure is created.

In particular, the open side of a respective cavity may have front openings and the bottom side and/or the lateral boundary of a respective cavity may have rear openings. It is advantageous in this regard when—in an orthogonal projection from the open side to the bottom side—a plurality of rear openings of the bottom side and/or the lateral boundary is located within an area defined by a front opening on the open side. In particular, an orthogonal projection is obtained when looking at the three-dimensional support structure from the inflow side with the viewing direction orthogonal to the surface of the three-dimensional support structure. One then sees the front openings formed at the inflow side as well as openings located within a respective front opening there behind, which are arranged closer to the outflow side. These rear openings are defined by a structure of the three-dimensional support structure located correspondingly further to the outflow side, such as a structure defining the bottom side of the cavity or a structure forming the lateral boundary of the cavity. However, in the orthogonal projection mentioned, only the part of the respective rear openings that lies within the area of the front opening on the inflow side is visible. The projected area of this part of the rear openings further to the outflow side in relation to the area of the front opening on the inflow side is to be considered here. If one looks through the front opening in orthogonal direction, one will usually see a plurality of seemingly smaller rear openings. For example, the rear openings may actually be smaller than the respective front opening on the open side. In this case, the rear openings may be arranged in any desired manner relative to the front opening. The rear openings, in particular rear openings at the bottom side of the cavity of the cage structure further towards the outflow side, may also be as large as or even larger than the respective front opening at the open side. In this case, however, the rear openings should be arranged with a lateral offset to the front opening on the open side, so that in the projection mentioned, i.e. when looking from the inflow side through the front opening on the open side, one always sees several rear openings at least in part.

In particular, the open side of a respective cavity of the three-dimensional support structure may have only one front opening. Thus, in this configuration, each cage structure has associated therewith exactly one front opening facing the inflow side, through which material for forming the surface filtration layer can be received in the cage structure.

The filter body may define a thickness direction extending between its inflow side and its outflow side. The surface filtration layer, for example, then can fill cavities of the three-dimensional support structure over at least 10% of the thickness of the surface filtration layer, in particular over at least 25% of the thickness of the surface filtration layer, in particular over at least 50% of the thickness of the surface filtration layer, in particular between 25% and 100% of the thickness of the surface filtration layer, in particular between 50% and 75% of the thickness of the surface filtration layer. This allows an advantageous connection or bond of the surface filtration layer with the filter body, in particular with the three-dimensional support structure. The greater the proportion of the surface filtration layer that is embedded in cavities of the three-dimensional support structure, the more durable the bond between the surface filtration layer and the support structure.

For example, the surface filtration layer can also fill cavities of the three-dimensional support structure over at least 10% of the thickness of the three-dimensional support structure, in particular over at least 25% of the thickness of the three-dimensional support structure, in particular over at least 50% of the thickness of the three-dimensional support structure, in particular between 25% and 100% of the thickness of the three-dimensional support structure, in particular between 50% and 75% of the thickness of the three-dimensional support structure. This also enables advantageous bonding of the surface filtration layer to the filter body, in particular to the three-dimensional support structure. The further the surface filtration layer extends into the support structure, the more durable the bond between the surface filtration layer and the support structure. In extreme cases, cavities of the three-dimensional support structure can be filled with material from the surface filtration layer over the entire thickness of the three-dimensional support structure. Then virtually all of the cavities formed by the three-dimensional support structure are filled with material of the surface filtration layer. Thus, the three-dimensional support structure may also be considered as a part of the surface filtration layer, especially in such cases in which the portion of the three-dimensional support structure filled with material of the surface filtration layer occupies a large part of the three-dimensional support structure and/or the surface filtration layer.

Depending on the configuration of the surface filtration layer material, the average degree of filling of cavities of the three-dimensional support structure with material for the surface filtration layer may vary. The coating method by means of which the material for the surface filtration layer is applied may also play a role. For example, with a coating material or coating process in which there is a strong tendency to form agglomerates between individual particles of coating material introduced into cavities of the three-dimensional support structure, it will already be possible to detect strong anchoring of the coating material at only moderate filling levels, in particular 50% or less, or about 30 to 50%, because agglomeration of particles causes bridge structures to form which are present across several adjacent cavities. With other coating materials or processes, such as those based on liquids, higher filling levels will be required to achieve the desired anchoring of the coating material in the three-dimensional support structure, such as at least 50% or at least 75%, and up to 100%.

According to the preceding embodiments, the surface filtration layer may be formed integrally or in one piece with the filter body. This relates in particular to the three-dimensional support structure, which in turn may be manufactured by the same additive process and in the same printing process as the filter body. In this sense, the filter body and surface filtration layer are then manufactured in one piece. This can reduce the number of process steps required and lower manufacturing costs. The cohesion between the filter body and surface filtration layer is also particularly good, especially when the composition of filter body and surface filtration layer, in particular a support structure or “mother pore structure” of the filter body and the three-dimensional support structure, differ only slightly or not at all. In particular, the support structure of the filter body and the three-dimensional support structure can be made of the same material.

Furthermore, it may be provided that the surface filtration layer comprises a first layer which at least partially, in particular to its greater part, fills cavities of the three-dimensional support structure. The first layer substantially forms a filling layer for the three-dimensional support structure. The indication “to a greater part” is intended to refer to the mass of the first layer, i.e. per surface area of the filter element, the part of the first layer (relative to its mass) that fills cavities of the support structure is greater than the part of the first layer that is applied to the three-dimensional support structure outside cavities. In particular, the first layer has at least 30% of its mass filling cavities of the three-dimensional support structure, in particular at least 65%, in particular at least 75%, in particular at least 85%, in particular at least 95%. In this way, the first layer provides for good anchoring of the surface filtration layer in the three-dimensional support structure and thus to the filter body. Despite the good anchoring, this filling of the three-dimensional support structure with the material of the first layer can be very porous, so that the flow resistance when flowing through the filter element remains within acceptable limits.

The filtration layer may have at least a second layer applied to the first layer from the inflow side. This can be done, for example, in such a way that the second layer forms a surface on the inflow side of the filter body. However, it is also conceivable that, in addition to the second layer, the first layer, and in some cases also the three-dimensional support structure itself, contribute to the formation of the surface on the inflow side of the filter body. The first layer can be considered as a basis for the at least second layer. With the at least second layer, it can easily be adjusted or set which foreign substances are to be filtered out of the gas stream before entering the filter body, in particular which foreign substances with a corresponding size. If applicable, the at least second layer may also comprise several layers on top of each other, with the respective layer forming the surface on the inflow side of the filter body through which the gas stream flows first in the direction of flow of the gas stream during filter operation. The second layer forms for the most part the surface filtration layer proper, if applicable together with the first layer. In further embodiments, the second layer together with parts of the first layer and even parts of the three-dimensional support structure may form the surface at the inflow side of the filter body.

The first layer and the second layer may have different pore sizes. In this case, the pore size of the first layer can be larger than the pore size of the second layer. This reduces the pressure loss of the gas flow through the filter element, because only a comparatively small thickness of the surface filtration layer on the inflow side needs to have a very low porosity. This low porosity thickness is mainly determined by the second layer, if applicable in cooperation with the first layer and/or the three-dimensional support structure. The porosity of the three-dimensional support structure can be very large without affecting its stability. Here, the advantages of additive manufacturing processes can be optimally exploited. The first layer can be formed from relatively coarse-grained material, so that even when the three-dimensional support structure is filled with material from the first layer, the flow resistance remains low and there is no significant pressure loss resulting for the gas flow when it passes through the filter element. The flow resistance is then essentially determined by the part of the surface filtration layer in which the second material is located. The thickness of this part can be chosen to be very small, resulting in only a low flow resistance overall.

Such a configuration also permits easy cleaning of the filter element, since a large part of the foreign substances will accumulate on a surface of the surface filtration layer and will not penetrate to deeper layers of the filter element with respect to the direction of flow of the gas stream. After the filter element has been cleaned-off, the filter quality of the filter element can thus be improved within short.

The surface filtration layer can be formed such that the first layer and the second layer form a transition region between them, in which material of the second layer penetrates into interstices between particles of the first layer and at least partially fills the same. This results in particular in a firm cohesion between the first layer and the second layer of the surface filtration layer.

The surface filtration layer may form a surface of the filter body, the surface being formed by the first layer and the second layer, in some embodiments even with the cooperation of the three-dimensional support structure. This allows for effective cleaning-off of the filter body, as the foreign substances remain on the surface of the filter body.

The at least second layer can form a surface on the inflow side that adheres to the first layer or fills cavities of the first layer and the three-dimensional support structure over at most 50% of the thickness of the support structure, in particular at most 25% of the thickness, in particular at most 5% of the thickness, in particular at most 1% of the thickness.

In particular, the pore size of the three-dimensional support structure may be between 100 μm and 2000 μm. The pore size of the second layer of the surface filtration layer can be in particular between 0.1 μm and 20 μm and the pore size of the first layer of the surface filtration layer can be in particular between 1 μm and 200 μm. The pore size describes an average pore diameter that arises on a surface of the corresponding layer or structure when the first layer or the second layer is made of a granular material, with pores forming between the granular material. The pore size can be checked and measured in particular with a pore measuring device. When “pores” or “pore size” are referred to here or in the following, this term is to be understood generally and is intended to include any type of pores, openings, cavities, open microstructures or other structures in which the structure of an otherwise solid body is structured such that a permeability for fluid results. For example, in some additive manufacturing processes, the targeted selection and definition of “voxels” (voxel means an elementary volume element in case of discrete subdivision of a three-dimensional space into elementary volume elements for addressing the three-dimensional space, analogous to “pixels” in two-dimensional objects) can purposefully create open microstructures which provide the same function for the object created in this way (filter element, filter body, surface filtration layer, in particular three-dimensional support structure) as pores in the conventional sense in conventionally manufactured sintered porous bodies.

The pore size can be measured, for example, with a capillary flow porometer PSM 165 from TOPAS. The operating principle of the measurement will be described below. If a medium is flowed through by a fluid, there is created a pressure loss which is significantly influenced by the pore size distribution. The resistance to the flow can only be determined by a flow test. The relationship between the effective pressure difference and the resulting volume flow is measured. In addition to other methods, such as microscopic images with corresponding evaluation, pore sizes can also be determined by applying pressure and measurement of volume flows. The operating principle of this measurement consists in that liquid-filled pores become permeable to gas at a certain pressure only, since the liquid must be displaced from the pore. The opening pressure (bubble point) for a pore depends on the surface tension of the liquid and the pore diameter. Smaller pores require a higher pressure. Since there is always a pore size distribution in real materials, the pressure at which the previously liquid-filled pore becomes permeable to gas corresponds to the opening pressure of the largest pore. When the pressure is increased further, the distribution of the pore diameter can be inferred from the course of the pressure difference and the volume flow.

In any case, the second layer may contain PE, PTFE, SiO₂, e.g. microglass, hollow glass, foam glass, solid glass or sand, PPS, aluminum oxide or a mixture of at least two of the above materials. In particular, the second layer may contain the above-mentioned materials in particle form. This allows good cleaning-off of the surface filtration layer. Furthermore, the surface filtration layer may also have a germicidal effect.

The surface filtration layer can be at least partially formed as a coating, but in any case the first and second layers can be formed as a coating, in particular by means of liquid deposition, spraying, brushing-on, dip coating, baking and/or a thermal spray process such as flame spraying. This permits a uniform surface filtration layer suitable for enabling good filtration performance. The coating can be applied quickly and easily. Furthermore, this allows the use of already proven methods for applying the surface filtration layer to the filter body. In general, the degree of filling of cavities of the three-dimensional support structure with material of the surface filtration layer (in particular with material of the first layer) will be higher with coatings resulting from coating processes based on liquids or suspensions than with coatings resulting from thermal spraying processes such as flame spraying or also other spraying processes. The reason for this is that in the latter processes the materials under consideration for the formation of the surface filtration layer are able to form bridges between particles accommodated in different cavities of the three-dimensional support structure. This results in good anchoring of the material of the first layer, even at relatively low filling levels of about 30% of the volume of the cavities in the three-dimensional support structure.

The three-dimensional support structure can have a framework—or truss-like configuration with rods connected to each other at nodes. A truss-like configuration is understood to mean that several rods are connected to each other at nodes, and thus the three-dimensional support structure has inherent stability and can exist without additional structures. In addition to the good inherent stability with high porosity, the advantage of the truss-like design is that formed cavities can have an approximately uniform distribution in the three-dimensional support structure. This allows efficient manufacture of a durable surface filtration layer. Relative to their load-bearing capacity, truss structures have a low dead or intrinsic weight. The three-dimensional support structure can also be produced, for example, by means of periodic minimal surfaces, in particular by means of triply periodic minimal surfaces. More generally, the three-dimensional support structure can also be formed from osteogenic or porous structures. The space available for fluid to flow through can be particularly large.

The three-dimensional support structure may have a grid-like structure forming at least two grid layers, of which one grid layer faces the inflow side, in particular defines the inflow side, and the other grid layer faces the outflow side. The grid layers can be connected to each other by rods or webs. The two grid layers are arranged one behind the other in the direction of flow of the gas stream as it passes through the filter element. The grid layer facing the inflow side can define the inflow side in the sense that, apart from the first and, if applicable, second layer of the surface filtration layer, no further structures are formed and thus the position of the filter surface is defined by the inflow side of the three-dimensional support structure. The two grid layers, and also further grid layers if provided, may be oriented substantially parallel to each other, wherein substantially parallel to each other shall also include an inclination relative to each other of plus/minus 10°. With the grid-like structure, uniform cavities can be realized, in particular with respect to the shape and size of the cavities, which can be easily and quickly filled with the surface filtration layer, in particular the particles thereof. The rods or webs connecting the at least two grid layers to each other extend transversely to the inflow side and/or outflow side, substantially in the direction of the gas flow as it passes through the filter element. Additional grid layers may be provided between the two grid layers. A configuration of the three-dimensional support structure with a total of three grid layers is particularly favorable. In this case, there is a further grid layer between the one grid layer defining the inflow side and the other grid layer facing the outflow side. The surface filtration layer at least partially fills an intermediate space between the two grid layers. This enables the surface filtration layer to be firmly and durably bonded to the support structure.

The one and/or the other grid layer may have a configuration with rods connected to each other at nodes and defining openings. This configuration defines a grid structure wherein a plurality of at least three adjacent rods, in particular four adjacent rods, of a respective grid layer each surround an opening of the grid layer. Arrangements with openings defined by a higher order polygon are conceivable as well. Then a plurality of n adjacent rods of a respective grid layer each surround one opening of the grid layer.

The one and/or the other grid layer may have a regular grid structure. The expression “regular grid structure” is to be understood in the sense that the arrangement of openings and rods of the respective grid layer has a regular pattern with repetitive configurations of rods relative to each other and/or openings. In particular, the configuration of rods of a respective grid layer then defines regular openings. For example, all openings of a grid layer may have the same size and/or the same shape. There may also be provided larger first openings and smaller second, third, etc. openings, with the arrangement of the first, second, third, etc. openings defining a regular pattern. The advantage of the regular grid structure is on the one hand stability and that the openings have an approximately uniform distribution in the regular grid structure. This permits efficient manufacture of a durable surface filtration layer.

The at least two grid layers may be arranged such that the openings of one of the two grid layers are offset from the openings of the other one of the two grid layers. This allows efficient filling of the cavities with the surface filtration layer, in particular with the particles of the surface filtration layer.

The three-dimensional support structure may comprise three grid layers arranged one behind the other in the flow direction between the inflow side and the outflow side of the filter body. The openings of the central grid layer can be offset from the openings of the other two grid layers. In particular, the grid layers each have the same configuration of rods and openings. This allows efficient filling of the cavities with the surface filtration layer, in particular with the particles of the surface filtration layer.

The three-dimensional support structure may comprise three grid layers arranged one behind the other in the flow direction between the inflow side and the outflow side of the filter body. The openings of the two outer grid layers can be arranged congruently with each other. In particular, the grid layers can each have identical configurations of rods and openings. Congruent is to be understood as congruent in relation to the direction of flow of the gas stream in filter operation.

The openings of the one, the other one and/or the central grid layer may be triangular, quadrangular, in particular square, rectangular, rhombic or diamond-shaped or parallelogram shaped, polygonal, round and/or elliptical.

The webs or rods connecting two adjacent grid layers each may be arranged offset from the nodes of the two grid layers. In particular, they can be arranged in the middle between two adjacent nodes. This means that the webs or rods connecting two adjacent grid layers start on both grid layers in a section, in particular in the middle, between two nodes. In this way, cage structures are formed between the two adjacent grid layers, which are well suited for retaining particles of the surface filtration layer, in particular particles of the first layer, and especially against movement in the direction transverse to the plane of the grid layers. The cage structures themselves have as small surface areas as possible so as not to obstruct the gas flow. Such an arrangement is favorable, for example, when the two grid layers are offset such that the nodes of one grid layer are centered on the center of the openings of the other grid layer. In an orthogonal projection, the nodes of one grid layer are then located at the center of the openings of the other grid layer. In this case, the rods or webs connecting the two grid layers to each other may also be orthogonal to the two grid planes and may each start at the center of rods or webs lying in the plane of a respective grid layer and connecting adjacent nodes of the respective grid layer.

It Is also conceivable that rods or webs, connecting two adjacent grid layers each, are arranged at the nodes of one grid layer and offset from the nodes of the respective other grid layer. This means that the webs or rods start at the nodes of the one grid layer but terminate in a section between two nodes of the respective other grid layer. For example, the webs or rods may start at the nodes of the grid layer located at the inflow side, but terminate in a section between two nodes of the central grid layer. Similarly, the webs or rods can start at the nodes of the grid layer located on the outflow side, but terminate in a section between two nodes of the central grid layer. In this way, too, respective cage structures are formed between the two adjacent grid layers, which are well suited for retaining particles of the surface filtration layer, in particular particles of the first layer.

The term grid layer describes in particular a layer that has several mutually parallel oriented webs or rods running in a first direction and several other mutually parallel oriented webs or rods running in a second direction. The first direction and the second direction are at an angle relative to each other, in particular at an angle of 90°. The webs or rods thus together form a grid or net. The section at which a web or rod running in the first direction intersects with a web or rod running in the second direction forms a node. Between two nodes there is then a section where the corresponding web or rod extends without interruption.

At least two grid layers define a pore structure. The pore structure has in particular a pore size between 1 μm and 10000 μm, in particular between 100 μm and 2000 μm. The pore size indicates the maximum diameter of a particle, in particular a round particle, which can just be accommodated in the pore. The two grid layers create parametric pores, i.e. pores which are formed by the arrangement of the at least two grid layers relative to each other. The pores of the grid layers are thus not randomly arranged but parametrically controlled. It is possible that a deliberate randomness of the pores is caused, for example with the aid of a randomizer, so that even the pores formed in this way, which are seemingly randomly formed, are created parametrically. This is advantageous when printing processes are used that can cope better with an irregular distribution. For example, in stereolithography, particle jetting and fused deposition modeling, a pore structure defined in CAD is implemented directly in the material. In processes that work in a powder bed (selective laser sintering, selective laser beam melting, binder jetting) by melting or bonding powder, it is advisable not to draw the pore structure as a solid material, but to create laser paths or bonding points in the CAD. Irregularities controlled within a certain parameter range, together with the irregular structure of the grain sizes of the material, then create the actual pores of the additively manufactured base body. The webs defining the pores thus can also be porous themselves.

The filter body may comprise furthermore a three-dimensional base structure, which will also be referred to as “mother pore structure” in the following. The three-dimensional support structure is disposed on an inflow side of the mother pore structure. The mother pore structure has a structure that is different from the three-dimensional support structure, the mother pore structure having, in particular, larger openings or pores than the three-dimensional support structure. The surface filtration layer is located on the side of the three-dimensional support structure facing away from the mother pore structure. The mother pore structure provides additional stability to the filter element. The mother pore structure also allows the gas stream, which has been swirled by the support structure, to calm down before it leaves the filter element.

The three-dimensional mother pore structure may have a larger pore size than the three-dimensional support structure. The filter body may comprise a UV-crosslinking thermosetting polymer material as the main constituent, in particular for the three-dimensional support structure and, if applicable, the mother pore structure. The main constituent may comprise polyethylene, polysulfone or polyphenylene sulfide, polyamide, e.g. nylon in laser sintering, or polyactides or mixtures of these materials.

The mother pore structure and the three-dimensional support structure can be manufactured in an additive manufacturing process, in particular in a 3D printing process. In particular, both structures can be manufactured in the same additive manufacturing process. This allows the filter body and thus the filter element to be manufactured quickly.

Both the mother pore structure and the three-dimensional support structure can be formed from a solid material or from a porous material.

The mother pore structure can be distinguished from the three-dimensional support structure, for example, in that the mother pore structure establishes and/or defines the contour of the filter body, whereas the three-dimensional support structure follows this contour of the filter body and establishes a connection to the surface filtration layer.

It should also be noted that the mother pore structure could also be manufactured without an additive manufacturing process, if desired. In that case, however, the advantages achievable by additive manufacturing processes would not be utilized.

The filter body may further comprise a three-dimensional supporting structure configured to form additional components, such as a filter element head or a filter element foot, on the filter body or to attach such additional components to the filter body. Such a three-dimensional supporting structure can also form the mother pore structure, or the mother pore structure can form such a three-dimensional supporting structure.

The filter body may comprise at least one additional constituent different from the main constituent, wherein the additional constituent comprises in particular fibers, in particular staple fibers, or a filled plastic. The additional constituent may have at least one of the following properties: antistatic properties, conductive properties, antibacterial properties, fungicidal properties, flame retardant properties.

The filter element can be designed as a hollow body, with the inflow side of the filter body being located on an outer side of the hollow body and the outflow side of the filter body being located on an inner side of the hollow body. In a cross-section through the filter body, the filter element can be cylindrical, fir-tree-shaped, lamella-shaped or polygon-shaped. Such cross-sections are well suited to create the largest possible surface area on the inflow side of the filter body while still providing the filter element with sufficient inherent stability.

The filter element may have furthermore a box-like shape, in particular an elongated box-like shape. The box may have two opposing wide side walls formed by a long side and a wide side of the box, respectively. At end faces of the box, two narrow walls extending in the depth direction connect the two wide side walls. Elongated means that an extension of the filter element in the longitudinal direction is significantly greater than in the width direction. In any case, an extension of the box in depth direction is significantly smaller than in longitudinal direction and in width direction.

The filter element may comprise furthermore a filter head and/or a filter foot to close the hollow filter body at an open end. In particular, the filter foot and/or the filter head may be formed so as to improve the inherent stability of the filter element. For example, the filter element may be held or supported on the filter head and/or the filter foot.

In particular, an arrangement is conceivable in this regard in which the filter head is arranged at a first end of the filter element and the filter foot is arranged at a second end of the filter element opposite the first end.

The filter head and/or the filter foot in particular can be formed integrally or in one piece with the base body. This is intended to express in particular that the filter head and/or the filter foot is formed in the same additive process as the basic body. Such an integral design can increase the stability of the entire filter element by avoiding joints, which usually constitute the weak points. In addition, process steps, possible retooling, etc. can be avoided during manufacture. The filter head and/or the filter foot can be formed from the same polymer material as the filter body. However, the filter head and/or the filter foot will generally be non-porous. Of course, the filter head and/or filter foot may also be formed from a respective specially matched polymer material.

The filter body and, If applicable, the surface filtration layer may comprise as a main constituent a thermoplastic polymer material, in particular polyethylene (PE), polypropylene (PP), polyphenylene sulfide (PPS), polyimide (PI), polyamide (PA), polyvinyl alcohol (PVA), polyactides (PLA) or a thermoplastic mixed polymer based thereon. The main constituent will usually have a larger share in the total composition than an additional constituent; the filter body and, if applicable, the surface filtration layer may well have several main constituents or the main constituent may be a mixed polymer. The addition of polyvinyl alcohol can be used specifically to create pore structures, since many polyvinyl alcohols are readily soluble in water and cavities can thus be formed by incorporating polyvinyl alcohol into the material of the filter body or the surface filtration layer and subsequently treating it with water. The addition of water also enables the targeted creation of pore structures. With this approach, the pore structure, in particular the pore size, can be well adjusted.

The filter body and, if applicable, the surface filtration layer may also comprise as a main constituent a thermosetting polymer material, in particular an epoxy resin, phenolic resin, polyester resin, melamine resin, silicone resin, urethane resin or a mixed polymer based on the same. In particular, polymer materials suitable for stereolithography or laser sintering can be used.

With a thermosetting polymer material as a main constituent, it is conceivable in particular that the filter body or the surface filtration layer comprises a UV-crosslinking thermosetting polymer material, for example epoxy acrylate, as a main constituent. Alternatively, polymer materials that crosslink by heat and/or crosslink in a humid environment are conceivable.

The filter body and, if applicable, the surface filtration layer may further comprise, in addition to one or more main constituents, at least one additional constituent that is different from the main constituent.

Suitable additional constituents include fibers, in particular staple or short fibers. The fibers may serve to increase strength and may be provided, for example, in particular as glass fibers, ceramic fibers, or plastic fibers such as aramid. The fibers may be carbon fibers, for example. Natural fibers are also possible. Mixtures of such fibers and the use of so-called filled plastics (plastic compounds) are also possible.

Filled plastics or compounds are processed plastics to which so-called additives (fillers, additives, fibers, etc.) have been added by certain processes in order to be able to specifically adapt their properties.

The filter element (filter body and, if applicable, surface filtration layer) may also have an additional constituent with antistatic properties. An example of such an additional constituent are soot particles.

Still further embodiments may comprise as an additional constituent conductive particles, e.g., made of silver or so-called doped plastic particles which have implemented electrons.

Other possible additional constituents may have antibacterial properties. Silver, copper or titanium oxide (TiO2) are conceivable for this purpose.

Still other conceivable additional constituents may have fungicidal properties. This can inhibit the formation of fungi on the filter body and/or the surface filtration layer. Such an additional constituent may be copper, for example.

It has also turned out to be advantageous if the additional constituent has flame-retardant properties. This can reduce the flammability of the filter body and, if applicable, of the surface filtration layer. This is particularly advantageous in connection with the filtering of combustible dusts. Such a constituent may be, for example, a plastic based on polyoxymethylene (POM), polysulfone (PSU) or polyphenylene sulfide (PPS). Constituents based on aluminum trihydrate (ATH), magnesium hydroxide, organic brominated compounds or layered silicates are possible as well.

Additive manufacturing processes allow the manufacture of fractal surface structures. This allows the surface area available for filtration to be increased very efficiently for given dimensions of the filter element. It is even possible to form the surface of the surface filtration layer in such a way that a lotus effect is created, which facilitates cleaning-off of the surface filtration layer.

In particular, the filter element may comprise a filter body that is manufactured in an additive manufacturing process based on photopolymerization. A continuous liquid interface production method is particularly suitable for this purpose. The continuous liquid interface production method has the advantage of a faster manufacturing speed of a component compared to other 3D manufacturing methods, since the component is continuously drawn from a polymer solution which is cured at predetermined locations, in contrast to the pronounced layer-by-layer structure of other 3D manufacturing methods.

Other additive manufacturing processes are also suitable for manufacturing the filter elements suggested here. In selective laser sintering (SLS) or selective laser melting (SLM), spatial structures are manufactured from a powdery starting material by selective irradiation with a laser, so that substantially point-like sintering of the powdery starting material takes place in the respective irradiated volume. The laser is passed across a layer of the powdered starting material and activated purposefully only at those locations where sintering of the powdered starting material is to take place in the layer. The filter body and, if applicable, the surface filtration layer are thus built up layer by layer. The effect of the laser beams allows any three-dimensional geometries to be manufactured, for example also with undercuts, which cannot be manufactured by conventional sintering. Also the pore structure can be easily controlled by suitable adjustment of the laser beam. Another suitable additive manufacturing process is so-called binder jetting, in which powdered starting material is bonded to a binder at selected locations in a layer, in order to thus manufacture the filter body and, if applicable, the surface filtration layer. In the binder jetting process, a powder or granular layer is usually applied to a height-adjustable table and bonded by means of a binder to the locations of the layer that are to form the pore walls of the filter body or the surface filtration layer. For this purpose, similar to an ordinary inkjet printer, a print head is used which applies the binder instead of ink.

### BRIEF DESCRIPTION OF THE DRAWINGS

The invention will be described in more detail in the following with reference to drawings, which are to be understood merely as exemplary. They are schematic, not to scale, and show only the features essential to an understanding of the present invention. It is understood that further features, as are familiar to a person skilled in the art, may be present. In the drawings, like reference numerals denote identical or corresponding elements each. The drawings show:

FIG. 1 an embodiment of a filter element according to the invention with a filter head and a filter foot;

FIG. 2 a central portion of a section through the filter element at the position designated II-II in FIG. 1;

FIG. 3 an enlarged sectional view of the sectional view of FIG. 2;

FIG. 4 an enlarged perspective view of the three-dimensional support structure of the embodiment of FIG. 2;

FIG. 5 an exemplary method for manufacturing the filter element according to the invention;

FIG. 6 a schematic representation of an exemplary manufacturing method for a filter element according to the invention; and

FIG. 7 a schematic representation of another possible manufacturing method for a filter element according to the invention.

### DETAILED DESCRIPTION

Features of the individual exemplary embodiments can also be realized in other exemplary embodiments, provided that they are technically feasible. They are therefore interchangeable, even if this is not pointed out separately each time in the following.

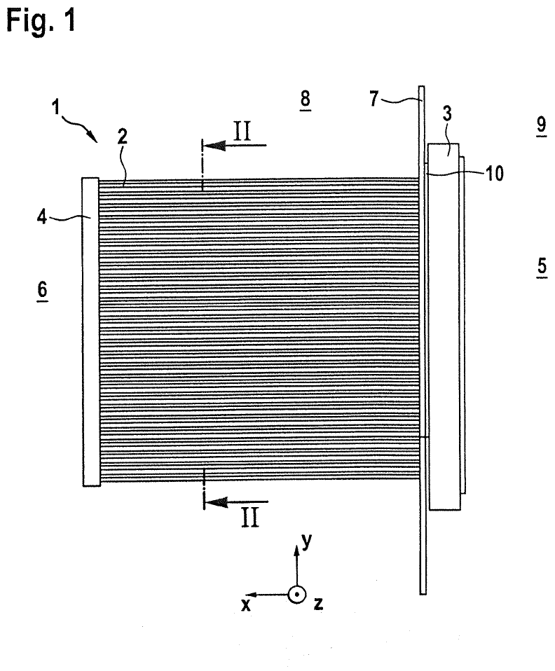

FIG. 1 shows a filter element 1 with a filter body 2 made of plastic. The filter body is made from a polymer material by means of an additive manufacturing process. The filter element 1 has a box-like shape, in particular the shape of a narrow box, the extension of which in the longitudinal direction (in FIG. 1, direction x) and width direction (in FIG. 1, direction y) is significantly greater than in a depth direction (in FIG. 1, direction z). In particular, the extension of the filter element in the longitudinal direction and/or in the width direction is at least twice as large or even at least five times as large or even at least ten times as large as in the depth direction. The filter element may have approximately the same dimensions in the longitudinal direction x and in the width direction y. If desired, the filter element may also be somewhat smaller in the width direction y than in the longitudinal direction x, but in any case the extension in the width direction y is also significantly larger than the extension in the depth direction z.

Furthermore, the filter element 1 has a filter head 3 and a filter foot 4, with the filter head 3 being arranged at an end on a first side 5 of the filter element 1 and the filter foot 4 being arranged at an end on a second side 6 of the filter element 1 opposite the first side 5. The embodiment of the filter element 1 shown in FIG. 1 is held on a partition 7 arranged on edge, which is part of a filter device not illustrated in more detail, and separates an inflow side 8 of the filter device from an outflow side 9. The inflow side 8, which can also be referred to as the raw gas side, corresponds to the side on which a gas stream loaded with foreign substances, the so-called raw gas, strikes the filter element 1, and the outflow side 9, which can also be referred to as the clean gas side, corresponds to the side on which the gas cleaned of the foreign substances, the so-called clean gas, is discharged. Accordingly, the filter element 1 has an inflow side and an outflow side.

The filter element 1 has its filter head 3 “laterally” fastened to the partition 7, which is arranged on edge, i.e. it extends from the partition 7 in the direction x. FIG. 1 shows the so-called clean-fluid-side installation of the filter element 1, in which a side surface of the filter head 3, which projects beyond the filter body 2 in the y-direction on both sides and is directed towards the filter foot 4, is attached to the partition 7 on the outflow side 9, and the filter body 2 of the filter element 1 projects through an opening in the partition 7. A seal 10 can be seen between the filter head 3 and the partition 7, which serves to seal between the inflow side 8 and the outflow side 9. This allows the filter element 1 to be replaced from the “clean” outflow side 9. In the exemplary embodiment illustrated here, the filter foot 4 closes one end of the filter body 2 so that the clean fluid leaves the filter body 2 through the filter head 3.

Alternatively, the so-called raw-gas-side installation of the filter element 1 is also conceivable, in which the filter head 3 is fastened from the inflow side 8 to the partition 7 with its side surface directed away from the filter foot 4. The filter element 1 is thus installed and removed via the inflow side 8.

Of course, it is also conceivable to fasten the filter element 1 in a suspended manner instead of laterally. The partition 7 is then provided transversely, preferably horizontally, in the filter device in the manner of an intermediate floor between, for example, a lower inflow side 8 and an upper outflow side 9. Also in this suspended installation position of the filter element 1, either clean gas side or raw gas side installation of the filter element 1 can be provided for.

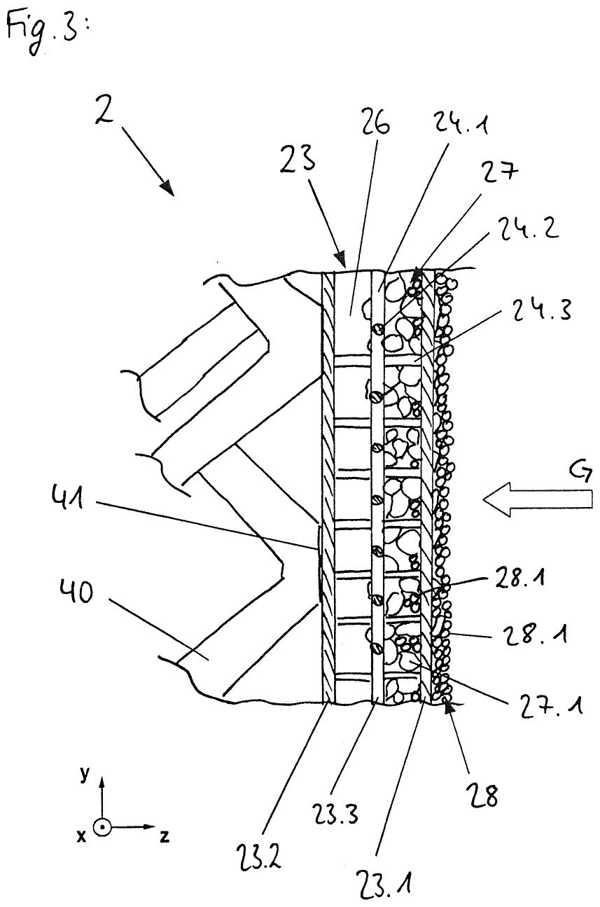

The filter body 2 comprises a porous, in particular throughflow-porous structure, which can be formed in different ways. An exemplary embodiment is shown in FIG. 3. A throughflow-porous structure is understood to be a structure which forms a coherent body which however is throughflow-porous from the inflow side 8 of the filter body 2 to the outflow side 9 of the filter body 2, i.e. a body (in this case the filter body 2) which is permeable to the passage of gas.

Furthermore, the filter body 2 of the filter element 1 according to the invention is also inherently stable, which means that the filter body 2 forms such a solid body structure that it can support its own weight by itself when, for example as shown in FIG. 1, it is held only at one end (filter head) in its longitudinal direction, or else is held at both of its ends that are spaced apart in the longitudinal direction by an additional support structure at the filter foot. Beyond the filter body 2, however, the filter element 1 does not have any further skeletal or supporting structure made of the same material as the filter body 2. In further embodiments, the filter element may have additional structures, such as a spring or other element, which is insertable into the filter body 2.

Such filter elements 1 are used, for example, in large industrial plants for cleaning exhaust gases and have a length of 1 cm to 5 m, in particular 5 cm to 3 m, and a width of 0.55 cm to 200 cm, in particular 1 cm to 100 cm, and a depth of 0.5 cm to 50 cm, in particular 1 cm to 25 cm. The filter elements may have a cross-sectional area usable for filtering in relation to the fluid flow of 0.0015 m² up to 25 m². The surface area actually available for surface filtration can be much larger than this cross-sectional area when the surface filtration layer is suitably structured by means of projections/depressions, surface roughness, fractal geometries or surfaces structured otherwise.

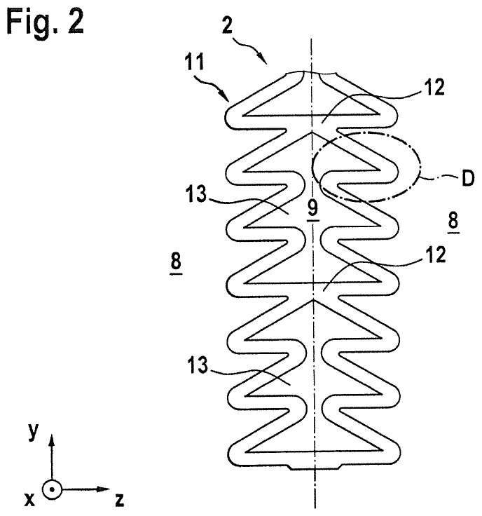

FIG. 2 shows a cross-sectional profile of the filter body 2 along the length of line II-II in FIG. 1 and in a central portion remote from the edges. It can be seen that the filter body 2 is formed as a hollow body and in the example shown here has a fir tree-like cross-section 11. However, round, cylindrical or polygonal cross-sectional areas are conceivable as well.

The fir tree-like design is particularly suitable because, compared with, for example, a smooth cuboid cross-sectional area with approximately comparable volume of the filter element 1, it forms a larger surface area that is located on the inflow side 8 (outer side) and is thus effective for filtration of the raw gas arriving there. The outflow side 9 is located inside the hollow body. After passing through the filter body of the filter element, the cleaned gas flows approximately orthogonally to the cross-sectional plane to the filter head.

It can be seen that the fir-tree-like cross-section 11 has continuous intermediate walls 12 at certain intervals, which divide the interior hollow space or cavity into a plurality of smaller hollow chambers 13. The intermediate walls 12 serve to ensure the stability of the filter body 2, and the number thereof can be selected in accordance with the desired stability. When the filter body 2 has sufficient inherent stability, it is also possible to dispense with the provision of intermediate walls 12.

For filtration of the foreign substances from the raw gas, the filter body 2 has a surface filtration layer 14 on its inflow side 8, as shown schematically and by way of example in FIG. 3.

The surface filtration layer 14 forms the main filter component. Foreign substances (particles) to be filtered out are trapped due to the small pore size of the surface of the surface filtration layer. Such material does not penetrate at all or only to a very small extent into the filter body 2, which serves mainly as a separating component between the raw gas side (inflow side 8) and the clean gas side (outflow side 9) that can be passed by the clean fluid.

The surface filtration layer 14 has a porous structure, as does the filter body 2, and is arranged on the inflow side 8 of the filter body 2 or partially in the filter body 2 on the inflow side. The average pore size in the surface filtration layer 14 is significantly smaller than the average pore size of the filter body 2. The average pore size in the surface filtration layer 14 is to be selected such that the foreign substances to be filtered from the raw gas cannot pass through the surface filtration layer 14 and are deposited on the surface of the same on the inflow side.

The filter body 2 may have an average pore size of about 100 μm to 2000 μm in regions outside the surface filtration layer 14, whereas the filter body, in regions in which the surface filtration layer 14 is formed, has a smaller average pore size, in many cases in a range of 0.1 μm to 200 μm.

At least a three-dimensional support structure 23, described in more detail below, which ensures a firm connection of the surface filtration layer 14 to the filter body 2, is manufactured additively. However, further constituents of the filter element 1 can also be manufactured additively, such as, for example, a mother pore structure 40 forming a porous base structure, a supporting structure for further components such as filter head 3 and/or filter foot 4, as well as the filter head 3 and/or the filter foot 4.

Additive manufacturing processes are understood to be processes in which a component is built up layer by layer on the basis of digital 3D design data by depositing material. In common language usage, additive manufacturing processes are also referred to as 3D printing processes. Known additive manufacturing processes are, for example, stereolithography, selective laser sintering (SLS), binder jet or fused layer modeling/manufacturing (FLM).

The additive manufacturing processes are particularly suitable for the manufacture of complex geometries, such as those with undercuts, cavities or overlaps, which cannot be manufactured using conventional manufacturing methods.

FIG. 3 shows an exemplary embodiment of the filter element 1 with filter body 2 having a multi-layer or multi-phase structure. The structure of the filter body 2 has a supporting structure. The supporting structure is designed such that it gives the filter element 1 or filter body 2 inherent stability and is sufficiently porous to allow a gas stream to flow through the filter body 2 with relatively low pressure loss. On an inflow side of the supporting structure, the structure of the filter body 2 has a basic structure 40 referred to as “mother pore structure”. The mother pore structure 40 is formed with a coarse-pore, gas-permeable configuration which is nevertheless inherently stable, i.e. can support its own or intrinsic weight without the aid of additional supporting elements. This coarse pore configuration has a larger pore size compared to other layers or phases of the filter body 2, in particular compared to the surface filtration layer 14. The mother pore structure 40 is formed as a truss or framework structure, which gives the filter body 2 a basic stability with a low intrinsic weight. The framework structure is to be regarded as an example, and there are also other structures conceivable which have good inherent stability with the lowest possible intrinsic weight and/or with the lowest possible flow resistance, for example a bionic structure. The supporting structure moreover forms additional components in corresponding portions of the filter body 2, such as the filter head or the filter foot, or is designed for attaching such components to the filter body 2.

On an inflow side 41 of the mother pore structure 40, which is arranged on the right side of the mother pore structure 40 in FIG. 3, there is arranged a three-dimensional support structure 23 designed as a truss or framework structure. Like the filter body 2 together with the mother pore structure 40, the support structure 23 is a component manufactured by way of additive manufacturing. Additive manufacturing allows the support structure 23 to have relatively large cavities 26 between the individual support structure components and still provide sufficient stability to create a stable filter layer, in particular to provide a stable and permanent connection to the surface filtration layer 14. In the present embodiment, this is achieved by the support structure 23 having a grid-like structure comprising three grid layers 23.1, 23.3, 23.2 arranged one behind the other in the direction of flow of the gas stream.

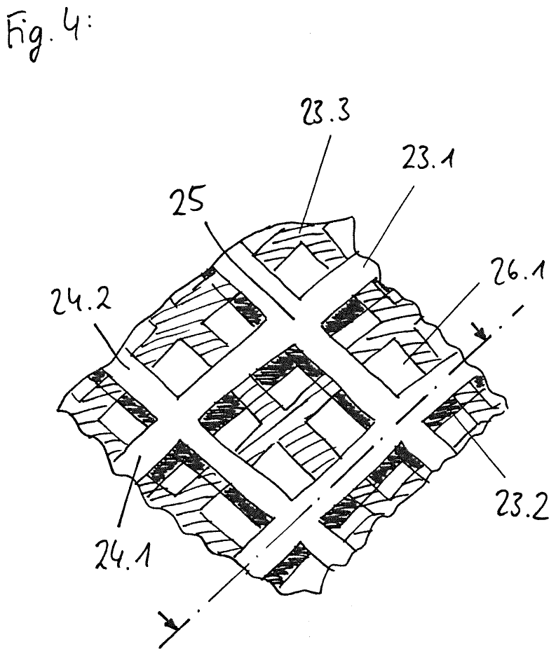

FIG. 4 shows a perspective view of the basic structure of the three-dimensional support structure 23. The position of the sectional plane for the sectional view of FIG. 3 is also indicated in FIG. 4, it being understood that neither the first layer 27 and second layer 28 of the surface filtration layer 14 nor the mother pore structure 40 are illustrated in FIG. 4 for the sake of clarity. The three-dimensional support structure 23 comprises a first grid layer 23.1 which forms an inflow side of the support structure 23 and defines an inflow side of the filter body 2, a second grid layer 23.2 which forms an outflow side of the support structure 23 and faces an outflow side of the filter body 2, and a third grid layer 23.3 which forms an intermediate layer between the first grid layer 23.1 and the second grid layer 23.2 in the flow direction. The cavities 26 are formed between and in the grid layers 23.1 to 23.3. The first grid layer 23.1 is also referred to as the front grid layer, the second grid layer 23.2 as the rear grid layer and the third grid layer 23.3 as the central grid layer.

The grid layers 23.1 to 23.3 are aligned substantially parallel to each other. A deviation of up to 10° relative to each other is to be regarded as substantially parallel as well. The grid layers 23.1 to 23.3 are arranged such that the gas stream G strikes the front grid layer 23.1 from a substantially normal direction and then passes through the grid layers 23.1, 23.2, 23.3 in this order. The grid layers 23.1 to 23.3 are each formed of rods 24.1 and 24.2 which are connected to each other at nodes 25. The rods 24.1 and 24.2 extend in the plane of the respective grid layers 23.1, 23.2, 23.3, i.e. transversely (in particular orthogonally) to the direction of flow of the gas stream as it passes through the grid layers 23.1 to 23.3. Each of the grid layers 23.1 to 23.3 is formed by a set of mutually parallel first rods 24.1, which run in a first direction, and a further set of mutually parallel second rods 24.2, which run in a second direction and cross the set of first rods. In the present embodiment, the second direction is approximately orthogonal to the first direction. The first and second rods 24.1 and 24.2 together define openings 26.1 (for clarity, only one of these openings 26.1 is provided with a reference numeral in FIG. 4). Each of the openings 26.1 is formed by two adjacent first rods 24.1 and two adjacent second rods 24.2 between the resulting four intersections of these first and second rods 24.1, 24.2. The intersections are also referred to as nodes 25. For each of the three grid layers 23.1, 23.2, 23.3, the openings 26.1 form so-called parametrically controlled pores through which the gas stream can pass through the corresponding grid layer 23.1 to 23.3. In particular, two adjacent rods 24.1 aligned parallel to each other and two adjacent rods 24.2 aligned parallel to each other form a respective one of the openings 26.1 therebetween. The openings 26.1 thus formed have a quadrangular, in particular square, shape in FIG. 4. Alternatively, the openings 26.1 may also be triangular, square, rectangular, diamond-shaped or rhombic, parallelogram-shaped, polygonal, round or elliptical. For the alternative embodiments of the openings 26.1, the corresponding grid layer may have a correspondingly different arrangement of multiple rods or multiple sets of rods which, joined together, define a respective opening 26.1 with multiple corners, for example honeycomb (hexagonal) openings 26.1. The openings 26.1 may also have different shapes within a corresponding grid layer, for example alternating pentagons and hexagons.

The grid layers 23.1 to 23.3 are interconnected by third rods 24.3, also referred to as grid layer connecting rods. These grid layer connecting rods 24.3 extend in a direction transverse to the plane of the respective grid layers 23.1, 23.3 or 23.2, 23.3 connecting the same. In particular, the grid layer connecting rods 24.3 extend in a direction orthogonal to the plane of the respective grid layers 23.1, 23.3 or 23.2, 23.3 connecting the same. In the embodiment illustrated, the front grid layer 23.1 and the central grid layer 23.3 have the same distance to each other as the rear grid layer 23.2 and the central grid layer 23.3 to each other. It is also possible that the distances between the grid layers 23.1 to 23.3 are mutually different, i.e. the distance between the grid layers 23.1 and 23.3 is different from the distance between grid layers 23.2 and 23.3. In the embodiment illustrated, the grid layer connecting rods 24.3 are aligned substantially along the direction of flow of the gas stream G.

With respect to the front grid layer 23.1 on the inflow side, the grid layer connecting rods 24.3 are arranged offset from the nodes 25. Also with respect to the adjacent central grid layer 23.3, the grid layer connecting rods 24.3 are arranged offset from the respective nodes 25. This means, for example, that one end (front end) of a respective one of the grid layer connecting rods 24.3 starts from one of the first rods 24.1 of the front grid layer 23.1 in a section between two nodes 25 (more precisely, in the middle between two nodes 25), whereas the other end (rear end) of the grid layer connecting rod 24.3 terminates in a section between two nodes 25 (more precisely, in the middle between two nodes 25) of one of the second rods 24.2 of the central grid layer 23.3. The same applies to grid layer connecting rods 24.3, one end of which starts from one of the second rods 24.2 in a section between two nodes 25 (more precisely, in the middle between two nodes 25) of the front grid layer 23.1, and the other end (rear end) of which terminates in a section between two nodes 25 (more precisely, in the middle between two nodes 25) of one of the first rods 24.1 of the central grid layer 23.3. Thus, the grid layer connecting rods 24.3 each connect a first rod 24.1 of one grid layer 21.1 to a second rod 24.2 of the adjacent grid layer 24.3 in a region not located at a node 25 (more precisely, located in the middle between two nodes 25).

Due to this arrangement, the cavities 26 form cage-like structures between each other, so-called parametrically controlled pores. The same applies to the grid layer connecting rods 24.3, which connect the rear grid layer 23.2 to the central grid layer 23.3.

A different orientation of the connecting rods 24.3 is also possible, for example inclined to the direction of flow of the gas stream G. With a correspondingly different offset of the central grid layer 23.3 with respect to the front grid layer 23.1, an arrangement not shown in the figures would also be conceivable in which, in relation to the front grid layer 23.1 on the inflow side, the grid layer connecting rods 24.3 are arranged at the nodes 25, and in relation to the adjacent central grid layer 23.3, the grid layer connecting rods 24.3 are arranged offset with respect to the respective nodes 25. Then, one end (front end) of the grid layer connecting rods 24.3 would terminate at one of the respective nodes 25 where the rod 24.1 crosses the rod 24.2 of the front grid layer 23.1, and the other end (rear end) of the grid layer connecting rods 24.3 would terminate between two adjacent ones of the nodes 25 at one of the rods 24.1 or one of the rods 24.2 of the third (central or middle) grid layer 23.3. Thus, the grid layer connecting rod 24.3 then would connect a node 25 of the front grid layer 21.1 to a rod 24.1 or 24.2 of the central grid layer 24.3 in a region not located at a node 25. Also by such an arrangement, the cavities 26 form cage-like structures between each other, so-called parametrically controlled pores. The same applies to the grid layer connecting rods 24.3, which connect the rear grid layer 23.2 to the central grid layer 23.3. With respect to the rear grid layer 23.2 on the outflow side, the grid layer connecting rods 24.3 are arranged at the nodes 25. However, with respect to the adjacent second (central) grid layer 23.3, the grid layer connecting rods 24.3 are arranged offset from the respective nodes 25.

In the exemplary embodiment, the grid layers 23.1 to 23.3 each have an identical and regular grid structure, which means that the arrangement of openings 26.1 and rods 24.1 and 24.2 of the respective grid layer 23.1 to 23.3 has a regular pattern with repetitive configurations of rods 24.1 and 24.2 with respect to each other and/or openings 26.1.

In the exemplary embodiment, the front grid layer 23.1 and the rear grid layer 23.2 are arranged congruently with respect to each other, and the central grid layer 23.3 is arranged offset from the grid layers 23.1 and 23.2 In particular, the openings 26.1 of the front grid layer 23.1 and the rear grid layer 23.2 are aligned with each other with respect to the direction of flow of the gas stream, and the openings 26.1 of the central grid layer 23.3 are offset transversely with respect to the direction of flow of the gas stream, in particular in a direction orthogonal to the direction of flow, so that the rods 24.1 and 24.2 of the central grid layer 23.3 can be seen in the direction of flow behind and in front of the openings 26.1 of the grid layers 23.1 and 23.2, respectively. In the embodiment illustrated, the offset of the central grid layer 22.3 from the front and rear grid layers 23.1, 23.2 is selected such that the nodes 25 of the central grid layer 23.3 are exactly aligned with the centers of the openings 26.1 of the front and rear grid layers 23.1, 23.2. In this way, the third rods 24.3 interconnecting the grid layers 23.1, 23.2, 23.3 can be orthogonal to the planes of the grid layers 23.1, 23.2, 23.3. Although all three grid layers 23.1, 23.2 and 23.3 each have the same regular grid structure, the offset of the central grid layer 23.3 with respect to the other two grid layers 23.1, 23.2 results in a kind of obstacle for the gas flow when passing through the porous structure (three-dimensional support structure 23) defined by the grid layers 23.1, 23.2, 23.3.

In this way, it is possible with an extremely uncomplicated geometry of the three grid layers 23.1, 23.2, 23.3—and thus with little expenditure—to form a cage structure which is excellently suited to embed material for forming the surface filtration layer 14 in cavities 26.1 of the three-dimensional support structure 23, in particular in cavities 26.1 between the front grid layer 23.1 and the central grid layer 23.3, and to retain it there against further transportation in the direction of flow of the gas stream G.

The three grid layers 23.1 to 23.3 are described merely as exemplary embodiments. It is also possible to use only two grid layers or more than three grid layers for the support structure.

Cavities 26 are created between the rods 24.1 and 24.2 within a respective one of the grid layers 23.1, 23.2, 23.3 and between the grid layers 23.1 to 23.3 and the grid layer connecting rods 24.3, which cavities 26, when viewed three-dimensionally, are connected to each other such that the gas stream G can flow through the cavities 26 from the inflow side 8 to the outflow side 9. In the cavities 26 between the front grid layer 23.1 and the central grid layer 23.3, there is arranged the surface filtration layer 14. The surface filtration layer 14 is formed by introducing and receiving particles of a first type 27.1 into the cavities 26 so that the particles of the first type 27.1 are embedded therein. Filling of the cavities 26 with particles of the first type 27.1 is effected such that a first layer 27 with a pore size between 1 μm and 200 μm is formed. For example, the particles of the first type 27.1 may have a grain size of 25 μm to 200 μm. In the exemplary embodiment, the particles of the first type 27.1 are mainly accommodated in cavities 26 between the front grid layer 23.1 and the central grid layer 23.3. In this regard, several particles of the first type 27.1 each occupy one of the cavities 26 and partly form agglomerates, in some cases even agglomerates with particles of the first type 27.1 which are accommodated in adjacent cavities 26. The first surface filtration layer 27 thus formed by interaction of the three-dimensional support structure 23 with particles of the first type 27.1 has a smaller pore size than the three-dimensional support structure 23 itself. The first surface filtration layer 27 forms a basis on which further layers, in particular a second surface filtration layer 28 or still further surface filtration layers can be applied.

The second surface filtration layer 28 is applied to the first surface filtration layer 27 from the inflow side. The second surface filtration layer 28 forms a surface of the filter element 1 on the inflow side 8. In the embodiment illustrated, the surface is formed exclusively, at least largely exclusively, by the second surface filtration layer 28. The second surface filtration layer 28 is arranged substantially on the three-dimensional the support structure 23 and the first surface filtration layer 27, and covers the latter towards the outside. In the embodiment, the second surface filtration layer 28 comprises a plurality of particles of a second type 28.1 (having a grain size between 0.1 μm and 20 μm), so that the second surface filtration layer 28 has a pore size between 0.1 μm and 20 μm. The pore size of the second surface filtration layer 28 is thus smaller than the pore size of the first surface filtration layer 27 and again smaller than the layers or structures following in the direction of flow of the gas stream. The size of the particles 28.1 allows the particles 28.1 to settle in pores formed in the first surface filtration layer 27 and also to at least partially overlie a surface of the surface filtration layer 27. The pores of the surface filtration layers 27 and 28 are arranged relative to each other such that they allow a gas stream to flow through the same. Due to the small pore size of the second surface filtration layer 28, the filter element 1 comprising this surface filtration layer 28 can be cleaned-off well and effectively.

In further embodiments, there are also configurations conceivable in which the second surface filtration layer 28 does not completely cover the first surface filtration layer 27 and, if applicable, also the three-dimensional support structure 23 towards the outside. In such embodiments, particles of the first type 27.1 and, if applicable, also parts of the three-dimensional supporting structure 23 are exposed to the outside. The surface of the filter element 1 is thus formed by the second surface filtration layer 28 in cooperation with the first surface filtration layer 27 and, if applicable, also the three-dimensional support structure 23.

During operation, an ever-increasing amount of foreign substances accumulates on the surface filtration layer 14 and forms a filter cake, the thickness of which increases with time and which gradually closes the pores of the surface filtration layer 14. This impairs the gas flow through the filter element 1, so that it is necessary to clean the surface filtration layer 14 from time to time. Conventionally, this is done by means of compressed air pulses, which are usually applied to the filter element 1 from the clean fluid side. In order to be able to do this during operation of the filter element 1, for example, the filter element can be subjected to a compressed air pulse so that a pressure surge is generated and transmitted through the filter element 1 to foreign substances adhering to the filter element 1 as a filter cake and the deposited foreign substances fall off the surface filtration layer 14, thus cleaning the pores and making them “free” again.

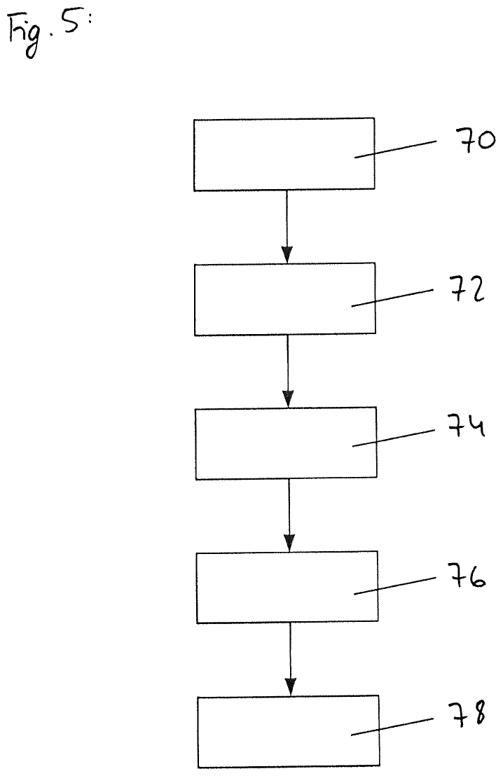

FIG. 5 shows a flow diagram of a method for manufacturing the inherently stable, throughflow-porous filter element 1. First, a supporting structure is manufactured in a first step 70 using an additive manufacturing process. The mother pore structure 40 can then be applied to this support structure in a second step 72. Subsequently, in a third step 74, the three-dimensional support structure 23 can be arranged on the mother pore structure 40 using the same additive manufacturing process. In this process, the cavities 26 are formed in the three-dimensional support structure 23. The steps described separately hereinbefore, forming the supporting structure (step 70), forming the mother pore structure 40 (step 72) and forming the three-dimensional support structure 23 (step 74), can also be carried out in one single additive manufacturing process, for example by simultaneously printing all three structures using a 3D printer.

This is followed in step 76 by forming the surface filtration layer by partially filling the cavities 26 of the three-dimensional support structure 23 with the particles of the first type 27.1 to form the first surface filtration layer 27. In the exemplary embodiment, the particles 27.1 mainly fill the cavities 26 formed between the grid layer 23.1 and the grid layer 23.3. In step 78, the second surface filtration layer 28 is deposited on the first surface filtration layer 27, with the particles 28.1 partially filling intermediate spaces formed between the particles 27.1. The second surface filtration layer 28 forms a porous surface on the first surface filtration layer, which has the smallest pore size across the filter body 2.

It is possible to carry out the entire exemplary method using the additive manufacturing process. The surface filtration layer can be realized, for example, via material gradients (SLS, SLM, binder jetting), additives in binders or polymers (FDM, SLA, binder jetting), via voxels from CAD (particle jetting, binder jetting, multijet fusion), machine paths and laser scanning speed (SLS, SLM). In a further exemplary embodiment, steps 70 to 74 can be carried out using an additive manufacturing process, and steps 76 and 78 can be carried out using one or more coating processes of the type described at the beginning.

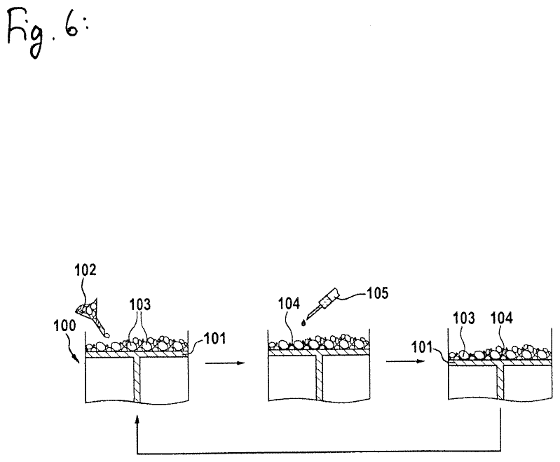

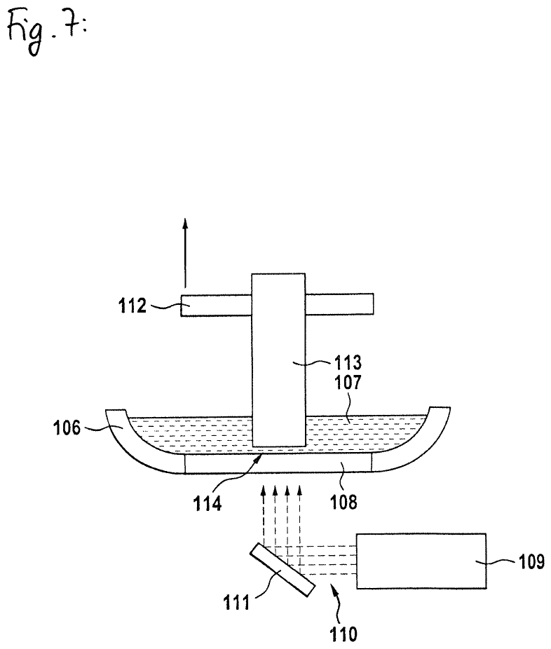

FIGS. 6 and 7 schematically show two possible additive manufacturing processes for manufacturing the filter element 1, or at least for manufacturing the filter body 2.

FIG. 6 shows an exemplary process according to the “bottom-up” principle, which means that the component to be manufactured is built up from “bottom” to “top”. The manufacturing method shown schematically proceeds as follows: A lowerable floor 101, which can also be referred to as a carrier plate 101, is arranged in a container 100. Plastic particles 103, for example as granules or powder, are applied to this carrier plate 101 in a predetermined dosage, for example by means of a dosing aid 102.

A mixture 104 of an adhesive, solvent (s) and/or water is then selectively applied to predetermined locations, for example by means of a dosing aid 105, in order to connect the plastic particles 103 there to each other, in order to thus form the first layer of the component to be manufactured. The dosing aid 105 may be designed, for example, as a print head (inkjet).

In a next step, the carrier plate 101 is lowered and the procedure is repeated. This is done until the component to be manufactured has been completely produced. After that, one can remove the plastic particles 103 that are not adhered and allow the water and/or solvent contained in the mixture 104 to evaporate, thus forming a porous body.

Instead of using water and/or solvent, it is also conceivable to use readily soluble resins that can be washed out of the component at the end in order to create the porosity.

Such a process can also be referred to as a binder jet process.

It is also conceivable to use, instead of an adhesive mixture, a pure adhesive (i.e. an adhesive without the addition of solvent and/or water and without the addition of readily soluble resins). This adhesive is applied by means of the dosing aid 105 selectively to individual locations in order to adhere them to each other.

Another process operating according to the “bottom up” principle is selective laser sintering (SLS), as described above, in which a laser is passed across a layer of powdered starting material in order to achieve sintering of the powdered starting material selectively at predetermined locations of the layer.

FIG. 7 schematically shows an exemplary process according to the “top-down” principle, which means that the component to be manufactured is built up from “top” to “bottom”. FIG. 10 shows as an example the so-called “continuous liquid interface production” process. The continuous liquid interface production process is a stereolithography process and differs from many other known additive manufacturing processes in that the component to be manufactured is built up continuously.

Conventional additive manufacturing processes usually work with so-called two-dimensional printing processes. A two-dimensional printing process means that a (thin) layer of the component to be manufactured is created and this process is repeated so often that the three-dimensional component to be manufactured is created layer by layer.

In principle, the continuous liquid interface production process proceeds as follows: a liquid polymer 107, e.g. a photosensitive synthetic resin, is provided on a trough-like platform 106. A floor 108 of the platform 106 is at least partially transparent to ultraviolet light (UV light). Below the platform 106, a light source 109 for UV light, for example a projector, is arranged, which emits one or more UV light beams 110. These are directed either directly or by deflection, for example by means of a mirror 111, through the floor 108 onto the liquid polymer and are precisely focused on the area where the liquid polymer is to cure.

Furthermore, the setup for the continuous liquid interface production process has a movable carrier plate 112 that can be moved in a direction perpendicular to the platform 106. Thus, by continuously moving the carrier plate 112, the component to be manufactured starting from the platform 106 is slowly withdrawn from the liquid polymer 107 so that the liquid polymer 107 can flow in. The last layer of the component 113 that has just been produced and the platform 106 thus always remain covered with the liquid polymer 107, which can be further cured by the UV rays 110.

Below the liquid polymer 107, an oxygen-permeable membrane is attached, which creates a transition phase that remains liquid, a so-called “dead zone” 114, which prevents the liquid polymer 107 from depositing on the floor 108 of the platform 106 and curing, e.g. polymerizing, there. Instead of an oxygen-permeable membrane, there are also other semi-permeable membranes conceivable which are permeable to a curing inhibitor other than oxygen, or polymerization inhibitor.

Thus, the “continuous liquid interface production” process represents a continuous printing process, whereby the manufacturing method is significantly shorter than other processes that produce the component layer by layer.

The choice and composition of the polymer material used to manufacture the plastic is directly related to the manufacturing method and vice versa.

Thus, the filter body 2 may have comprise a thermoplastic polymer material as a main constituent. This material includes polyethylene (PE), polypropylene (PP) and polyphenylene sulfide (PPS), which so far have also been used as filter body material. However, other thermoplastic polymers, such as polyimide (PI), polyamide (PA), polyvinyl alcohol (PVA), polyactides (PLA) or polyetheretherketone (PEEK), or thermoplastic mixed polymers are conceivable as well. In particular, thermoplastic polymers classified as “engineering thermoplastics” or as “high-performance thermoplastics” are conceivable.

Depending on the operating conditions and the resulting required properties that the filter element 1 is required to have, it may be possible for a thermosetting polymer material to be used instead of a thermoplastic polymer material. Thermosetting polymer materials include in particular epoxy resin, phenolic resin, polyester resin, melamine resin, silicone resin, and urethane resin. Again, a mixed polymer based on a thermosetting polymer material is conceivable. The main difference between thermosetting and thermoplastic polymer materials is that the polymer material is cured in the case of thermosets, and as a result these are much more strongly crosslinked and can therefore no longer be melted. As a rule, this also results in a higher probability of crack formation.

UV-crosslinking polymer materials are particularly suitable for a continuous additive manufacturing process, such as the continuous liquid interface production process. It is also conceivable to replace the UV light radiation by other specific radiation of the light spectrum, for example infrared light radiation (IR light radiation). In this case, polymer materials are to be selected which cure, i.e. crosslink, by irradiation with IR light radiation.

1. An inherently stable, throughflow-porous filter element for filtering foreign substances from a gas stream, comprising:
a filter body made of plastic and having an inflow side and an opposite outflow side, with a surface filtration layer being formed on the inflow side,
wherein the filter body comprises a three-dimensional support structure manufactured in an additive manufacturing process and having cavities through which gas can flow from the inflow side to the outflow side, and
wherein the surface filtration layer at least partially fills the cavities of the three-dimensional support structure.

2. The filter element according to claim 1,
wherein the three-dimensional support structure has a cage structure that is open towards the inflow side; wherein the three-dimensional support structure forms basket-like, cup-like or funnel-like cavities, each having a bottom side and an opposite open side, the open side facing the inflow side; wherein the basket-like, cup-like or funnel-like cavities each have a lateral boundary which connects the bottom side to the open side and has openings through which adjacent basket-like, cup-like or funnel-like cavities are in communication with one another.

3-4. (canceled)

5. The filter element according to claim 2,
wherein the open side of a respective cavity has front openings and the bottom side and/or the lateral boundary has rear openings, wherein in an orthogonal projection from the open side to the bottom side, a plurality of rear openings of the bottom side and/or the lateral boundary is located within an area defined by a front opening of the open side.

6. The filter element according to claim 3,
wherein the open side of a respective cavity has only one opening.

7. The filter element according to claim 1,
wherein the filter body defines a thickness direction extending between its inflow side and its outflow side, and the surface filtration layer fills cavities of the three-dimensional support structure over at least 10% of the thickness of the surface filtration layer, wherein the filter body defines a thickness direction extending between its inflow side and its outflow side, and the surface filtration layer fills cavities of the three-dimensional support structure over at least 10% of the thickness of the three-dimensional support structure.

8. (canceled)

9. The filter element according to claim 1,
wherein the surface filtration layer comprises a first layer which partially, substantially completely fills cavities of the three-dimensional support structure; wherein the surface filtration layer comprises at least one second layer which is applied to the first layer from the inflow side, wherein the second layer forms a surface on the inflow side of the filter body; wherein the second layer at least partially occupies interstices in the first layer; wherein the first layer and the second layer have different pore sizes, wherein the pore size of the first layer is larger than the pore size of the second layer; wherein the second layer contains particles selected from the group consisting of PE, PTFE, SiO₂, hollow glass, solid glass, foam glass or sand, PPS, aluminum oxide, or a mixture of at least two of said materials.

10-13. (canceled)

14. The filter element according to claim 9,
wherein the first and the second layer of the surface filtration layer are formed as a coating.

15. The filter element according to claim 1,
wherein the three-dimensional support structure has a truss-like configuration with rods which are connected to each other at nodes; and/or wherein the three-dimensional support structure comprises a grid-like structure forming at least two grid layers of which one grid layer faces the inflow side, and the other grid layer faces the outflow side, the grid layers being connected to each other by rods or webs.

16. (canceled)

17. The filter element according to claim 15,
wherein the one and/or the other grid layer has a configuration with rods interconnected at nodes and defining openings; wherein the one and/or the other grid layer comprises a regular grid structure.

18. (canceled)

19. The filter element according to claim 15,
wherein the at least two grid layers are arranged such that the openings of one of the two grid layers are arranged offset from the openings of the other one of the two grid layers.

20. The filter element according to claim 15,
wherein the three-dimensional support structure comprises three grid layers lying one behind the other in the direction of flow between the inflow side and the outflow side of the filter body, with openings of the central grid layer being arranged offset from openings of the other two grid layers and/or wherein the three-dimensional support structure comprises three grid layers lying one behind the other in the direction of flow between the inflow side and the outflow side of the filter body, with openings of the two outer grid layers being arranged in congruent manner.

21. (canceled)

22. The filter element according to claim 15,
wherein the openings of the one, the other one and/or the central grid layer are triangular, quadrangular, in particular square, rectangular, rhombic or parallelogram-shaped, polygonal, round and/or elliptical and/or wherein the webs or rods connecting two adjacent grid layers each are arranged offset from the nodes of the two grid layers.

23. (canceled)

24. The filter element according to claim 1,
wherein the filter body comprises furthermore a three-dimensional mother pore structure, wherein the three-dimensional support structure is arranged at the inflow side of the three-dimensional mother pore structure; wherein the three-dimensional mother pore structure has a larger pore size than the three-dimensional support structure.

25. (canceled)

26. The filter element according to claim 1,
wherein the filter element is formed as a hollow body, wherein the inflow side of the filter body is arranged on an outer side of the hollow body and the outflow side of the filter body is arranged on an inner side of the hollow body.

27. A method of manufacturing an inherently stable, throughflow-porous filter element for filtering foreign substances from a gas stream, wherein a filter body is formed of plastic and having an inflow side and an opposite outflow side, the method comprising the steps of:
manufacturing a three-dimensional support structure by means of an additive manufacturing process, such that cavities are formed in the three-dimensional support structure, through which cavities gas can flow from the inflow side to the outflow side;
forming a surface filtration layer by partially filling the cavities of the three-dimensional support structure,
wherein the three-dimensional support structure comprises a plastic material.

28. The method according to claim 27,
wherein a cage structure open towards the inflow side is formed when the three-dimensional support structure is manufactured by means of the additive manufacturing process and/or wherein during manufacture of the three-dimensional support structure by means of the additive manufacturing process, basket-like, cup-like or funnel-like cavities are formed, each having a bottom side and an opposite open side, the open side facing the inflow side.

29. (canceled)

30. The method according to claim 28,
wherein for each of the basket-like, cup-like or funnel like cavities a lateral boundary is formed which connects the bottom side to the open side and has openings through which adjacent ones of the basket-like, cup-like or funnel-like cavities communicate with each other and/or wherein front openings are formed in the open side of a respective cavity and rear openings are formed in the bottom side and/or the lateral boundary thereof, wherein in an orthogonal projection from the open side to the bottom side, a plurality of rear openings of the bottom side and/or the lateral boundary is located within an area defined by a front opening of the open side.

31. (canceled)

32. The method according to claim 30,
wherein only one opening is formed in the open side of a respective cavity.

33. The method according to claim 28,
comprising embedding material in cavities of the support structure to form a first layer of the surface filtration layer, such that a larger part of the material for the first layer fills cavities of the three-dimensional support structure and/or comprising applying at least one second layer to the first layer, in particular such that the second layer forms a surface filtration layer on the inflow side of the filter body, wherein the surface filtration layer is formed as a coating.

34-35. (canceled)

36. The method according to claim 28,
wherein during manufacture of the three-dimensional support structure by means of an additive manufacturing process, a truss-like configuration is formed with rods or webs which are connected to each other at nodes and/or wherein during manufacture of the three-dimensional support structure, there is formed a grid-like structure forming at least two grid layers, one grid layer defining the inflow side and the other grid layer facing the outflow side, wherein the grid layers are interconnected by rods or webs.

37. (canceled)
